(19) United States
(12) Patent Application Publication
(10) Pub. No.: US 2012/0039087 A1
(43) Pub. Date: Feb. 16, 2012

(54) DISPLAY DEVICE

(75) Inventors: CHAO-CHANG LEE, Tu-Cheng (TW); YUAN LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/096,224

(22) Filed: Apr. 28, 2011

(30) Foreign Application Priority Data
Aug. 11, 2010 (CN) 201010250883.3

(51) Int. Cl. F21V 7/22

(52) U.S. Cl. 362/606

(57) ABSTRACT

A display device includes a top housing, a bottom housing engaged with the top housing, and a display module. The top housing and the bottom housing cooperatively define a receiving space for the display module. The display module includes a light source and a light guide plate. The light guide plate includes a light input surface adjacent to the light source, a light output surface, and a bottom surface opposite to the light output surface. The light input surface connects the light output surface to the bottom surface. The inner surface of the bottom housing includes a reflective portion opposite to the bottom surface of the light guide plate, such that the reflective portion reflects the light emitting from the bottom surface to the light output surface.

### BACKGROUND

1. Technical Field

The present disclosure relates generally to display devices, and more particularly, to a display device having a reflective portion.

2. Description of Related Art

A display device includes a display panel that displays image information, and a backlight module that provides light to the display panel. The backlight module includes a light source, a light guide plate, a reflecting sheet, a prism sheet, a diffusion sheet, a fixing frame and a plastic frame. The light source is placed beside the light guide plate. The reflecting sheet is placed below the light guide plate. The prism sheet, the diffusion sheet and the display panel are stacked on the light guide plate in that order. The reflecting sheet is configured to reflect the light emitting from the bottom surface to the emitting surface of the light guide plate, such that the efficiency of utilization of light energy may be improved. However, the assembly process of the display device is complicated, and the display device is relatively thick because too many components are stacked together.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a display device including a top housing, a bottom housing, and a display module.

FIG. 2 is an exploded, isometric view of the display device of FIG. 1 in which the top housing is omitted.

FIG. 3 is an isometric view of the display device of FIG. 1 in which the top housing is omitted.

### DETAILED DESCRIPTION

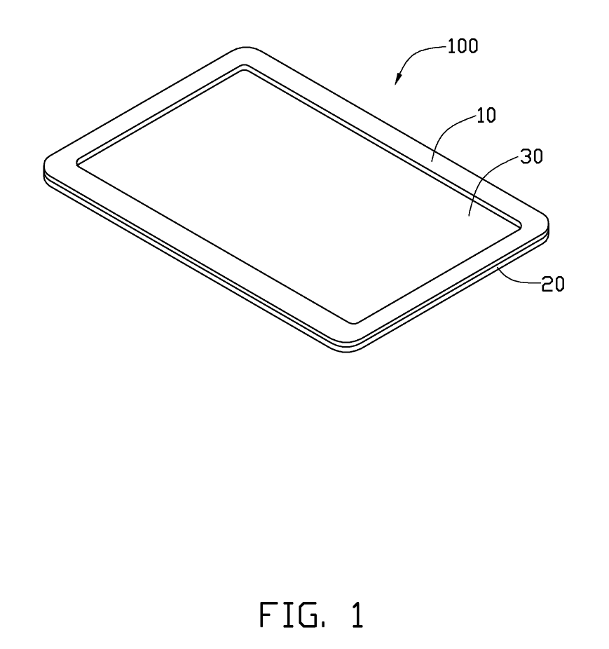

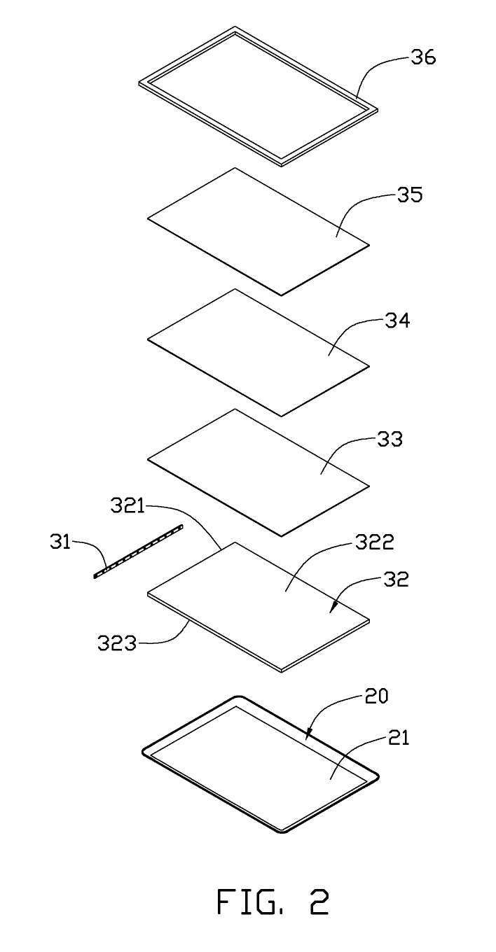

Referring to FIGS. 1 and 2, an embodiment of a display device 100 includes a top housing 10, a bottom housing 20 engaged with the top housing 10, and a display module 30. The top housing 10 and the bottom housing 20 may be connected by a latching module (not shown), and cooperatively define a receiving space for the display module 30.

The display module 30 includes a light source 31, a light guide plate 32, a prism sheet 33, a diffusion sheet 34, a display panel 35, and a fixing frame 36. The light source 31 includes an emitting surface. The light guide plate 32 includes a light input surface 321, a light output surface 322, and a bottom surface 323. The light input surface 321 is adjacent to the light output surface 322, and connects the light output surface 322 to the bottom surface 323. The light output surface 322 is opposite to the bottom surface 323. The light guide plate 32 is adjacent to the light source 31, and the light input surface 321 faces the emitting surface of the light source 31. The prism sheet 33 is placed on the light guide plate 32. The diffusion sheet 34 is placed on the prism sheet 33. The display panel 35 is placed on the diffusion sheet 34. The fixing frame 36 fixes the light source 31, the light guide plate 32, the prism sheet 33, the diffusion sheet 34, and the display panel 35 together.

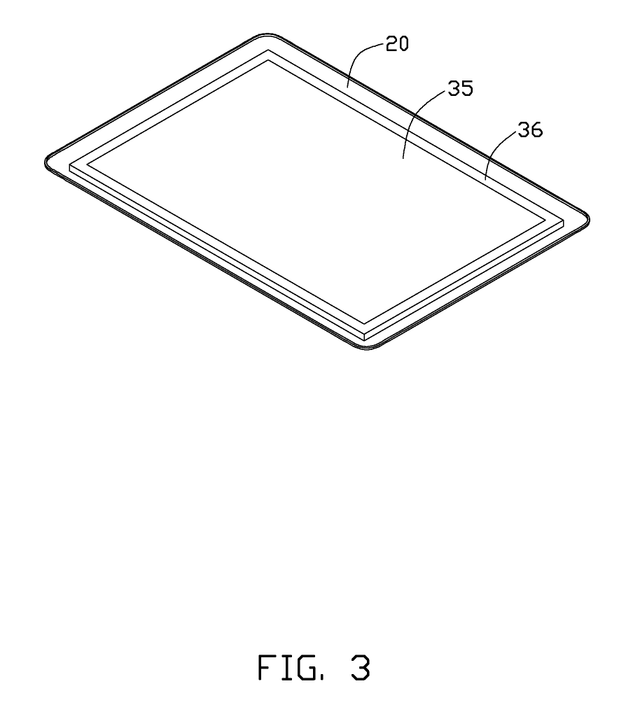

Referring to FIGS. 2 and 3, the inner surface of the bottom housing 20 includes a reflective portion 21. In the illustrated embodiment, the bottom housing 20 may be made of metal having high reflectivity which is equal to or greater than 95%, such as aluminum alloy, copper alloy, magnesium ally, silver, and so on, and thus the reflective portion 21 can reflect light emitting from the bottom surface 323. In the alternative embodiment, the bottom housing 20 can also be made of plastic material having high reflectivity, especially white plastic material, such as polyethylene terephthalate (PET), and polycarbonate (PC). It can be appreciated that the reflective portion 21 may be polished to further improve the reflectivity. It should be noted that the bottom housing 20 can also be made of materials having ordinary reflectivity, and then the reflective portion 21 is polished to improve the reflectivity.

With the display module 30 is fixed on the inner surface of the bottom housing 20 by the fixing frame 36, and the reflective portion 21 is opposite to the bottom surface 323 of the light guide plate 32, the reflective portion 21 can reflect the light emitting from the bottom surface 323 to the light output surface 322 of the light guide plate 32, which improves the efficiency of utilization of light energy. Known special reflecting sheet can be omitted with the present disclosure, such that the display device 100 has relatively fewer components and a smaller thickness, thereby being more compact and easily assembled.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A display device, comprising:
a top housing;
a display module, the display module comprising a light source and a light guide plate adjacent to the light source, wherein the light guide plate comprises a light input surface, a light output surface, and a bottom surface opposite to the light output surface, the light input surface connects the light output surface to the bottom surface; and
a bottom housing engaged with the top housing, the bottom housing and the top housing cooperatively defining a receiving space to receive the display module, wherein the inner surface of the bottom housing comprises a reflective portion opposite to the bottom surface of the light guide plate, such that the reflective portion reflects the light emitting from the bottom surface of the light guide plate to the light output surface.

2. The display device of claim 1, wherein the reflective portion is made of aluminum alloy, copper alloy, magnesium alloy or silver.

3. The display device of claim 1, wherein the reflective portion is made of white plastic material.

4. The display device of claim 3, wherein the white plastic material is polyethylene terephthalate or polycarbonate.

5. The display device of claim 1, wherein the reflective portion is polished.

6. The display device of claim 1, wherein the reflectivity of the reflective portion is equal to or greater than 95%.
